(19) United States
(12) Patent Application Publication
(10) Pub. No.: US 2020/0174823 A1
(43) Pub. Date: Jun. 4, 2020

(54) STATE MANAGEMENT METHOD AND APPARATUS FOR VIRTUAL MACHINE, AND SMART TERMINAL THEREOF

(71) Applicant: CLOUDMINDS (SHENZHEN) ROBOTICS SYSTEMS CO., LTD., Shenzhen (CN)

(72) Inventor: Yangang LI, Shenzhen (CN)

(21) Appl. No.: 16/786,691

(22) Filed: Feb. 10, 2020

Related U.S. Application Data
(63) Continuation of application No. PCT/CN2017/097154, filed on Aug. 11, 2017.

(51) Int. Cl. G06F 9/455; G06F 9/48; G06F 9/4401

(52) U.S. Cl. CPC G06F 9/45558; G06F 2009/45575; G06F 9/4418; G06F 9/4831

(57) ABSTRACT

A state management method for a virtual machine includes: at a smart terminal: receiving a suspend instruction for the virtual machine, the suspend instruction including a target sleep state of the virtual machine; enabling the virtual machine to enter a sleep state based on the suspend instruction; acquiring in real-time a sleep stage register value of the virtual machine; and suspending operation of a virtual CPU of the virtual machine when the sleep stage register value matches the target sleep state.

### CROSS-REFERENCE TO RELATED APPLICATIONS

This application is a continuation of International Application No. PCT/CN2017/097154 with an international filing date of Aug. 1, 2017, the entire contents of which are incorporated herein by reference.

### TECHNICAL FIELD

The present application relates to the technical field of virtualization, and in particular, relates to a state management method and apparatus for a virtual machine, and a smart terminal thereof.

### BACKGROUND

With constant growth of hardware cost, the virtualization technology represented by virtual machines is in drastically development because of low cost, high security and the like merits.

At present, to save total energy consumption of a system, when a virtual machine has no active task, a virtual central processing unit (CPU) of the virtual machine may be enabled to execute an idle instruction to suspend the virtual machine such that the virtual machine enters a sleep state and waits to be waken up by an interrupt signal. When the virtual machine receives the interrupt signal, the virtual machine is waken up. After the virtual machine is waken up, the virtual machine may be resumed to an operation state before being suspended.

However, the inventors have identified that the related art has at least the following problem: in the conventional state management technologies for the virtual machine, suspension of the virtual machine is practiced by running the idle instruction by the virtual CPU. In this way, after being suspended, the virtual machine is still in a schedulable state, and a virtual clock of the virtual machine may still normally operate. When the virtual clock sends an interrupt signal, the virtual machine may be triggered to exit the sleep state. If the waken-up virtual machine still satisfies a condition for being suspended, the virtual machine may be suspended again, such that the virtual machine is constantly and cyclically being suspended and waken up. It is difficult to truly reduce energy consumption of the system, and the energy saving effect is not good.

### SUMMARY

An embodiment of the present application provides a state management method for a virtual machine. The method includes: at a smart terminal: receiving a suspend instruction for the virtual machine, the suspend instruction comprising a target sleep state of the virtual machine: enabling the virtual machine to enter a sleep state based on the suspend instruction; acquiring in real-time a sleep stage register value of the virtual machine; and suspending operation of a virtual CPU of the virtual machine when the sleep stage register value matches the target sleep state.

Another embodiment of the present application provides a smart terminal. The smart terminal includes: at least one processor; and a memory communicably connected to the at least one processor; wherein the memory stores instructions executable by the at least one processor, wherein, the instructions, when being executed by the at least one processor, cause the at least one processor to perform the steps of receiving a suspend instruction for the virtual machine, the suspend instruction comprising a target sleep state of the virtual machine; enabling the virtual machine to enter a sleep state based on the suspend instruction; acquiring in real-time a sleep stage register value of the virtual machine; and suspending operation of a virtual CPU of the virtual machine when the sleep stage register value matches the target sleep state.

Still another embodiment of the present application provides a non-transitory computer readable storage medium. The non-transitory computer-readable storage medium stores computer-executable instructions, which, when being executed by a smart terminal, cause the smart terminal to perform the steps of: receiving a suspend instruction for the virtual machine, the suspend instruction comprising a target sleep state of the virtual machine; enabling the virtual machine to enter a sleep state based on the suspend instruction; acquiring in real-time a sleep stage register value of the virtual machine; and suspending operation of a virtual CPU of the virtual machine when the sleep stage register value matches the target sleep state.

### BRIEF DESCRIPTION OF THE DRAWINGS

One or more embodiments are illustrated by way of example, and not by limitation, in the figures of the accompanying drawings, wherein components having the same reference numeral designations represent like components throughout. The drawings are not to scale, unless otherwise disclosed.

FIG. 1 is a schematic diagram of an application environment of a state management method for a virtual machine according to an embodiment of the present application;

FIG. 2 is a schematic flowchart illustrating a suspend method for a virtual machine according to an embodiment of the present application;

FIG. 3 is a schematic flowchart of a wake-up method for a virtual machine according to an embodiment of the present application;

FIG. 4 is a schematic flowchart of another state management method for a virtual machine according to an embodiment of the present application;

FIG. 5 is a schematic structural diagram of a state management apparatus for a virtual machine according to an embodiment of the present application; and

FIG. 6 is a schematic structural diagram illustrating hardware of a smart terminal according to an embodiment of the present application.

### DETAILED DESCRIPTION

For clearer descriptions of the objectives, technical solutions, and advantages of the present application, the present application is further described with reference to specific embodiments and attached drawings. It should be understood that the specific embodiments described herein are only intended to explain the present application instead of limiting the present application.

It should be noted that, in the absence of conflict, embodiments of the present application and features in the embodiments may be incorporated, which all fall within the protection scope of the present application. In addition, although logic function module division is illustrated in the schematic diagrams of apparatuses, and logic sequences are illustrated in the flowcharts, in some occasions, steps illustrated or described by using modules different from the module division in the schematic diagrams of the apparatuses or in sequences different from those illustrated.

A state management method for a virtual machine according to the embodiments of the present application includes a suspend method for a virtual machine and a wake-up method for a virtual machine. After a virtual machine is suspended by using the suspend method for the virtual machine according to the embodiments of the present application, processes in a user space and a kernel space of the virtual machine are frozen, a virtual central processing unit (CPU), a virtual clock and the like virtual devices of the virtual machine are all paused. That is, the virtual devices of the virtual machine stop responses to scheduling by a host operating system, such that a process that the virtual machine is constantly and cyclically suspended and waken up due to mis-wake-up by an interrupt signal generated by the virtual clock is prevented, and thus energy consumption of the system is effectively reduced. Further, in the wake-up method for the virtual machine according to the embodiments of the present application, the virtual machine in the sleep mode may be waken up only when an active wake-up source is received (that is, operation of the virtual CPU is resumed to resume an operation state before the virtual machine is suspended), which further prevents mis-wake-up of the virtual machine and further reduces energy consumption of the system.

The state management method and apparatus for the virtual machine according to the embodiments of the present application may be applicable to any type of smart terminals, for example, a robot, a smart phone, a server, a personal computer, a tablet computer, a wearable smart device, a smart home appliance or the like. With the state management method and apparatus for the virtual machine, and the smart terminal according to the embodiments of the present application, the virtual machine may be absolutely suspended, and mis-wake-up of the virtual machine may be prevented, such that energy consumption of the system is effectively reduced.

Hereinafter the embodiments of the present application are further illustrated with reference to the accompanying drawings.

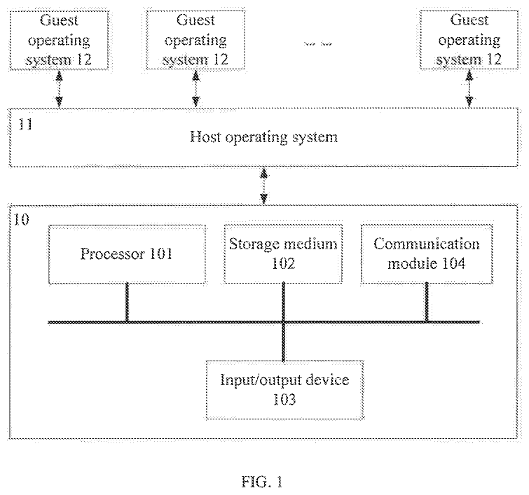

FIG. 1 is a schematic flowchart illustrating an application environment of a state management method for a virtual machine according to an embodiment of the present application. The application environment may be a computer system environment running on a smart terminal. Specifically, as illustrated in FIG. 1, the application environment includes: a physical hardware device 10, a host operating system 10 and a plurality of guest operating systems 12.

The physical hardware device 10 is an actually existent hardware device, and may include any suitable device components constituting a complete computer system, including, but not limited to: a processor 101, a storage medium 102, an input/output device 103, a communication module 104, and the like.

Specifically, the processor 101 may be any suitable type of processor having a specific logic operation capability, for example, a CPU, a graphics processor or the like. The processor 101 may include a plurality of kernels for use in multiple threads or parallel processing.

The storage medium 102 may include a memory module, for example, a ROM, a RAM, a flash module, and a large-capacity memory, for example, an optical disk and a hard disk. The storage medium 102 stores computer programs, which, when being executed by the processor 101, may perform various corresponding method steps or processes.

The input/output device 103 may be any suitable type of peripheral device that provides one or more user interaction manners, for example, a mouse, a keypad or a touch input screen for receiving a user action operation instruction, a motion sensing video camera, a microphone for acquiring audio information or a display screen for exhibiting image information for a user or a loudspeaker for outputting audios. The input/output device 103 may select to use a wired or wireless peripheral device to connect to another physical hardware device.

The communication module 104 may include some network interface devices that establish a connection via a wired or wireless communication network, for example, a network cable interface, a bus interface, a USB interface, a module or a Bluetooth communication module or the like.

In practical applications, the physical hardware device 10 may also be added with one or a plurality of devices to accommodate the requirements in different practical applications, for example, a database or a server device is added.

The host operating system 11 and the guest operating system 12 are both computer programs for managing and controlling the physical hardware device 10 and corresponding software resources, and is most basic system software that runs on a “naked” computer, and any other software may run only under support of the host operating system 11 or the guest operating systems 12. In the embodiment of the present application, the host operating system 11 and the guest operating systems 12 may be any suitable type of operating systems, for example, Linux, Unix, iOS, Android, Windows or the like, for receiving a user instruction and outputting and exhibiting a corresponding processing result for the user.

The host operating system 11 and the plurality of guest operating systems 12 share the physical hardware device 10. In practical running, the host operating system 11 may directly use hardware in the physical hardware device, whereas the guest operating systems 12 may use a virtual device provided by the virtual machine driving the guest operating system 12. The “virtual machine” refers to a computer system that is simulated by software, has the functions of a hardware system, and is running in an absolutely isolated environment. The virtual machine may form a plurality of simulated hardware devices (that is, the “virtual devices” in the embodiments of the present application) based on the physical hardware device 10 or software programs for use by the guest operating systems. One virtual machine correspondingly drives one guest operating system, and each of the virtual machines may run as an application in the host operating system 11. Therefore, suspending/waking up a virtual machine may be considered as suspending/waking up a guest operating system corresponding to the virtual machine.

Memory isolation is present between different operating systems. Even the host operating system 11 may not access a memory space of the guest operating system 12. As such, when the computer system includes two or more than two guest operating systems 12, if one of the guest operating systems 12 is re-started up due to an exception, the host operating system 11 and the remaining guest operating systems 12 may still run normally and may be isolated from each other. However, since the virtual machine runs as an application on the host operating system, if the host operating system 11 is re-started up due to an exception, all the guest operating systems 12 need to be re-started up for operation. Likewise, if the host operating system 11 is suspended, all the guest operating systems 12 may also be suspended. Accordingly, when the system has a plurality of guest operating systems 12, after all the guest operating systems 12 enters the sleep mode, the host operating system 11 may enter the sleep mode.

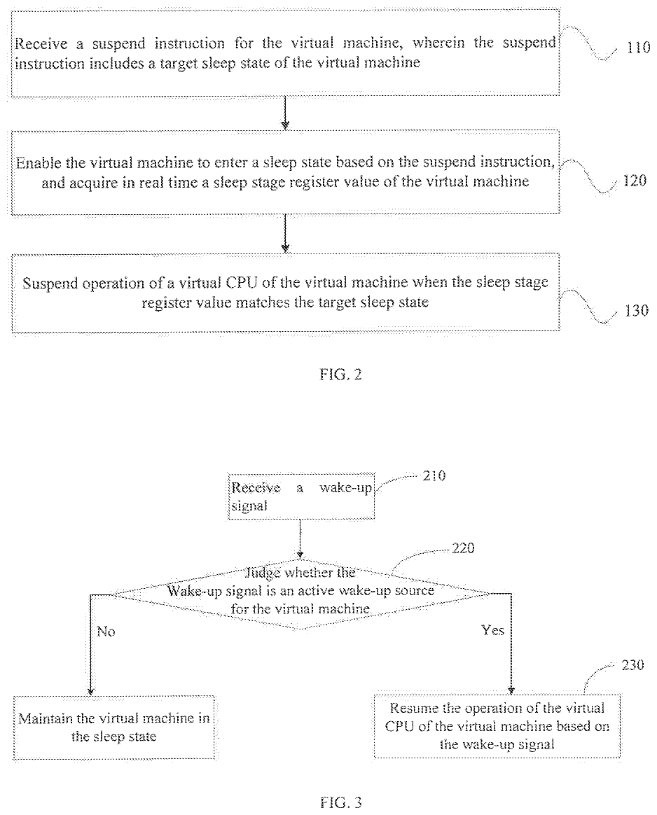

In the embodiments of the present application, when a user inputs an instruction for suspending a guest operating system 12 in a smart terminal, or when a current operation state of a guest operating system 12 satisfies a suspend condition predefined by the smart terminal with respect to the guest operating system 12, for example, when a guest operating system 12 has no active task within a predefined time period, an suspend instruction for suspending the guest operating system 12 is triggered. When the smart terminal receives the suspend instruction, a virtual machine corresponding to the guest operating system 12 may be suspended by using the suspend method for the virtual machine as illustrated in FIG. 2 according to the embodiments of the present application, that is, a suspend instruction for the virtual machine is received, wherein the suspend instruction includes a target sleep state of the virtual machine; the virtual machine enters the sleep mode based on the suspend instruction, and a sleep stage register value of the virtual machine is acquired in real time; and operation of a virtual CPU of the virtual machine is suspended when the sleep stage register value matches the target sleep state. Based on the above manner, after being suspended, the virtual machine may not be mis-waken up due to an interrupt of a virtual clock or other virtual devices, such that the virtual machine is absolutely suspended, and energy consumption of the smart terminal is reduced.

It should be noted that the “target sleep state” refers to a sleep state which the system of the smart terminal desires the virtual machine to enter, and the target sleep state may be acquired from the suspend instruction for the virtual machine. The sleep state of the virtual machine may include, but not limited to: doze, medium sleep, deep sleep, hibernation and the like. The virtual machine may be waken up in different ways with respect to these different sleep states, and the deeper the sleep state, the greater the difficulty to wake up the virtual machine. Further, the process that the virtual machine enters the sleep state is a progressive stage from light sleep to deep sleep. Each sleep stage corresponds to a different sleep stage register value. Therefore, in the embodiments of the present application, the “sleep stage register value” is used to characterize the specific sleep stage which the virtual machine currently enters. When the virtual machine ultimately enters the target sleep state, the operation of the virtual CPU is suspended. After the virtual CPU is paused, the virtual CPU may not make responses to scheduling of the host operating system 11, such that the virtual machine is absolutely suspended, that is, the guest operating system 12 completely stops running.

After the guest operating system 12 enters the sleep state, when the user needs to continuously use the guest operating system 12, the user may input a wake-up signal for waking up the guest operating system 12 to the smart terminal; or when the smart terminal detects that the guest operating system 12 satisfies a predefined wake-up condition, a wake-up signal is automatically triggered. Upon receiving the wake-up signal, the smart terminal may wake up the virtual machine corresponding to the guest operating system 12 by using any wake-up manner, such that the virtual machine is resumed to an operation state before being suspended. In particular, to further prevent the virtual machine from being mis-waken up by some inactive wake-up signals, a wake-up method for a virtual machine as illustrated in FIG. 3 according to the embodiments of the present application may also be used to wake-up the virtual machine. That is, after a wake-up signal is received, whether the wake-up signal is an active wake-up source for the virtual machine is judged firstly. If the wake-up signal is an active wake-up source for the virtual machine, operation of a virtual CPU of the virtual machine is resumed based on the wake-up signal; and otherwise, the virtual machine is maintained to be in the sleep state. Since the virtual CPU is a core virtual device in the virtual machine, when the operation of the virtual CPU is resumed, the virtual machine is waken up, and enters the operation state before the virtual machine is suspended. Based on the above manner, the virtual machine may be further prevented from being waken up by some inactive wake-up signals.

It should be noted that the “wake-up signal” refers to a signal that enables a virtual machine to exit a sleep state/a suspend state. The wake-up signal may include a plurality of types/forms. For example, the wake-up signal may be a signal for starting up a virtual power source corresponding to the virtual machine, charging the smart terminal, switching between guest operating systems, making calls or the like. Such signals may be configured based on functions of the guest operating systems 12. When the virtual machine receives a wake-up signal configured to the guest operating systems, the virtual CPU of the virtual machine is resumed to an operation state. In addition, in some embodiments, the type of the wake-up signal (that is,) may also be notified to the guest operating systems 12, such that the guest operating systems 12 perform a corresponding task based on the type of the wake-up signal.

In addition, it may be understood that when all the guest operating systems 12 in the computer system of the smart terminal are in the sleep state, likewise, a physical host corresponding to the host operating system 11 may be suspended by using the suspend method for the virtual machine according to the embodiments of the present application; and when the host operating system 11 is in the sleep mode, a physical host corresponding to the host operating system 11 may also be waken up by using the wake-up method for the virtual machine according to the embodiments of the present application.

Further, it should be noted that the state management method for the virtual machine according to the embodiments of the present application includes the suspend method for the virtual machine and the wake-up method for the virtual machine. These two methods may be uncooperatively used or may be independently used. In addition, the state management method for the virtual machine according to the embodiments of the present application may be further applied to other suitable application environments, instead of being limited to the application environment as illustrated in FIG. 1. In practical application, the application environment may also include more and fewer guest operating systems, and more or fewer types of physical hardware devices.

Specifically, FIG. 2 is a schematic flowchart illustrating a suspend method for a virtual machine according to an embodiment of the present application. Referring to FIG. 2, the method includes the following steps:

110: A suspend instruction for the virtual machine is received, wherein the suspend instruction includes a target sleep state of the virtual machine.

In this embodiment, the “suspend instruction” refers to an instruction that enables the virtual machine to enter the sleep state. The suspend instruction includes a target sleep state of the virtual machine. The “target sleep state” refers to a sleep state which the system of the smart terminal desires the virtual machine to enter.

In this embodiment, a suspend instruction for entering a sleep state which a virtual machine is desired to enter may be triggered in any suitable fashion. For example, a user inputs an instruction for “suspending a virtual machine A, and entering a sleep state of doze”. Still for example, if a virtual machine B has no active task within 20 minutes, and the current power amount of the smart terminal is only 50%, the smart terminal automatically triggers a suspend instruction for “enabling the virtual machine B to enter a sleep state of deep sleep”.

When the smart terminal receives a suspend instruction for a virtual machine, firstly a target sleep state of the virtual machine is determined based on the suspend instruction, and then steps 120 to 130 are performed. In this embodiment, each virtual machine corresponds to a sleep state register. The value recorded in the sleep state register is a sleep state register value of the virtual machine, and is used to characterize the target sleep state of the virtual machine. Accordingly, specific practice of determining the target sleep state of the virtual machine based on the suspend instruction may be: directly extracting the sleep state register value of the virtual machine from the suspend instruction, and updating the sleep state register value to the sleep state register; or setting the sleep state register of the virtual machine based on the suspend instruction, and then reading the sleep state register value of the virtual machine from the sleep state register.

120: The virtual machine is enabled to enter a sleep state based on the suspend instruction, and a sleep stage register value of the virtual machine is acquired in real time.

In this embodiment, each virtual machine further corresponds to a sleep stage register. The value registered in the sleep state register is the “sleep stage register value” of the virtual machine, and is used to characterize a sleep stage which the virtual machine currently enters. Different sleep stages correspond to different sleep stage register values.

In this embodiment, after a suspend instruction for a virtual machine is received, the target sleep state/sleep state register value of the virtual machine is determined based on the suspend instruction, and meanwhile, the virtual machine is enabled to enter the sleep state based on the suspend instruction. Further, since the process that the virtual machine enters the sleep state is a progressive stage from light sleep to deep sleep, the value recorded in the sleep stage register of the virtual machine is updated in real time with the sleep stage which the virtual machine enters. Therefore, in step 120, the sleep stage register value of the virtual machine is acquired in real time to determine the sleep stage which the virtual machine enters.

130: Operation of a virtual CPU of the virtual machine is suspended when the sleep stage register value matches the target sleep state.

In this embodiment, if the acquired sleep stage register value matches the target sleep state of the virtual machine, it indicates that the virtual machine has already enters the target sleep state, and the virtual machine has made well preparations for the suspension. That is, relevant files or data have been hacked up to a suspend state (.vmss or .vmem) file set of the virtual machine. In this case, the operation of the virtual CPU of the virtual machine may be suspended. After the operation of the virtual CPU is suspended, the virtual machine is completely suspended, and makes no response to scheduling of the host operating system.

Whether the acquire sleep stage register value matches the target sleep state may be determined by comparing the sleep stage register value acquired in step 120 with the sleep state register value acquired in step 110. If the sleep stage register value is the same as the sleep state register value (for example, the sleep state register value is 010100, and the sleep stage register value is also 010100), or if the sleep stage register value corresponds to the sleep state register value (for example, the sleep state register value is 010100, and the sleep stage register value is 101011), it may be considered that the acquired sleep stage register value matches the target sleep state of the virtual machine. Nevertheless, it may be understood that, in practical application, whether the acquired sleep stage register value matches the target sleep state of the virtual machine may also be determined based on other predefined rules, which is not specifically defined in this embodiment of the present application.

As known from the above technical solution, in the suspend method for the virtual machine according to this embodiment of the present application, the operation of the virtual CPU is suspended after the virtual machine completely enters the target sleep state, such that the virtual machine is completely suspended, and energy consumption of the smart terminal is reduced.

Further, an embodiment of the present application further provides a wake-up method for a virtual machine with respect to any virtual machine in a sleep state. Referring to FIG. 3, the method includes the following steps:

210: A wake-up signal is received.

In this embodiment, the “wake-up signal” refers to a signal that enables a virtual machine to interrupt/exit a sleep state/a suspend state. The wake-up signal may include a plurality of types/forms. For example, the wake-up signal may be a signal for starting up a virtual power source corresponding to the virtual machine, charging the smart terminal, switching between guest operating systems, making calls or the like.

In this embodiment, any virtual machine in a sleep mode may constantly receive a wake-up signal via a rear-end application. After any type of wake-up signal is received, step 220 is performed.

In particular, when the smart terminal has a plurality of virtual machines (guest operating systems), the plurality of virtual machines share the same physical hardware device. If the plurality of virtual machines are waken up simultaneously at a moment, and the virtual machines simultaneously call a physical hardware device, system operation failures may be simply caused. Therefore, in this embodiment, when the smart terminal has a plurality of virtual machines (guest operating systems), to prevent system operation failures caused when the virtual machines are waken up at the same moment, a priority may be configured for the wake-up signal corresponding to each virtual machine based on execution priorities of the virtual machines. Correspondingly, when two or more than two wake-up signals are received at a moment, firstly, a wake-up signal having a highest priority is extracted from the wake-up signals, and then steps 220 and 230 are performed based on the wake-up signal having the highest priority. That is, whether the wake-up signal having the highest priority is an active wake-up source for the virtual machine is judged based on the wake-up signal having the highest priority; and if the wake-up signal having the highest priority is an active wake-up source for the virtual machine, the operation of the virtual CPU of the virtual machine is resumed based on the wake-up signal having the highest priority. The execution priorities of the virtual machines may be defined by the user, or may be configured based on the functions of the virtual machines, which is not specifically defined in the embodiment of the present application.

For example, assuming that the smart terminal has a virtual machine A and a virtual machine B, the execution priority of the virtual machine A is higher than that of the virtual machine B, the active wake-up source of the virtual machine A is a wake-up signal a, the active wake-up source of the virtual machine B is a wake-up signal b, it may be determined based on the execution priorities of the virtual machine A and the virtual machine B that the priority of the wake-up signal a is higher than that of the wake-up signal b. If the virtual machine A and the virtual machine B are both in the sleep state in this case, and the smart terminal simultaneously receives the wake-up signal a and the wake-up signal b, the wake-up signal (which is the wake-up signal having the highest priority) may be extracted from these two wake-up signals, and then steps 220 to 230 are performed based on the wake-up signal a. With respect to the virtual machine A, the wake-up signal a is an active wake-up source, such that the operation of the virtual CPU of the virtual machine A may be resumed based on the wake-up signal a; and with respect to the virtual machine B, the wake-up signal a is not an active wake-up source for the virtual machine B, and thus the virtual machine B is maintained in the sleep state. In this way, at the same moment, the smart terminal only wakes up the virtual machine having the highest execution priority (for example, the virtual machine A), which prevents the problem of system operation failures caused when the plurality of virtual machines are started up simultaneously.

220: Whether the wake-up signal is an active wake-up source for the virtual machine is judged.

In this embodiment, the “active wake-up source” refers to a particular wake-up signal that is capable of waken up a virtual machine from the current sleep state. The same virtual machine may be correspondingly provided with different active wake-up sources in different sleep states, and the number of wake-up sources may not be limited to 1.

In this embodiment, when a wake-up signal is received, the wake-up signal is firstly analyzed to judge whether the wake-up signal is an active wake-up source for the virtual machine. If at least two wake-up signals are received, and each of the wake-up signals has a priority, the wake-up signal having a highest priority among these wake-up signals is analyzed to judge whether the wake-up signal having the highest priority is an active wake-up source for the virtual machine. If the wake-up signal is an active wake-up source for the virtual machine, step 230 is performed; and if the wake-up signal is not an active wake-up source for the virtual machine, the virtual machine is still maintained in the sleep state.

In this embodiment, for simplification of the judgment process, the smart terminal may assign a serial number to each of all possible wake-up signals, and thus each wake-up signal corresponds to a unique wake-up serial number. A wake-up source setting register is correspondingly defined for each virtual machine, and the value recorded in the wake-up source setting register is referred to as a “wake-up source register value”, which is used to record a serial number of an active wake-up source for the virtual machine in the current sleep state. The “wake-up source register value” may be configured in the wake-up source setting register based on the sleep state which the virtual machine enters, after the virtual machine is suspended. Based on this, specific practice of judging whether the wake-up signal is an active wake-up source for the virtual machine may be: firstly acquiring a wake-up serial number corresponding to the wake-up signal; then judging whether the wake-up serial number matches the wake-up source register value of the virtual machine; if the wake-up serial number matches the wake-up source register value of the virtual machine, determining that the wake-up signal is an active wake-up source for the virtual machine; and otherwise, determining that the wake-up signal is not an active wake-up source for the virtual machine.

230: The operation of the virtual CPU of the virtual machine is resumed based on the wake-up signal if the wake-up signal is an active wake-up source for the virtual machine.

In this embodiment, after it is determined that the received wake-up signal (or the wake-up signal having the highest priority among the plurality of wake-up signals) is an active wake-up source for the virtual machine, the operation of the virtual CPU of the virtual machine is resumed based on the wake-up signal. Specific practice of resuming the operation of the virtual CPU of the virtual machine based on the wake-up signal may be: directly resuming an operation state of the virtual CPU of the virtual machine to the operation state based on the wake-up signal before the virtual machine is suspended.

In addition, since a virtual machine may correspond to a plurality of active wake-up sources in the same sleep state, to improve response speed and accuracy of the virtual machine after being waken up, in this embodiment, the specific practice of resuming the operation of the virtual CPU of the virtual machine based on the wake-up signal may also be: firstly acquiring a wake-up source type of the wake-up signal, and then resuming the operation of the virtual CPU of the virtual machine based on the wake-up source type. For example, if the currently acquired wake-up source type of the wake-up signal is call, the operation of the virtual CPU of the virtual machine is firstly resumed based on the wake-up signal, that is, a task in the user space frozen when the virtual machine is suspended; and meanwhile, a task relevant to the “call” is scheduled in the operating system of the virtual machine.

As known from the above technical solution, in the wake-up method for the virtual machine according to this embodiment of the present application, the operation of the virtual CPU of the virtual machine is resumed only after the virtual machine receives an active wake-up source, which may further prevents mis-wake-up of the virtual machine,

In addition, since the virtual machine is completely suspended and makes no response to scheduling by the host operating system after the virtual machine is suspended by using the suspend method for the virtual machine according to this embodiment of the present application, the operation state of the virtual machine (guest operating system) may not be synchronized to the host operating system. When the physical host (host operating system) is suspended and thus the host enters the sleep state, if a virtual machine (guest operating system) is currently in an operating state, in this case, the virtual machine (guest operating system) may be interrupted and forcibly enabled to enter the sleep state. In this way, content running on the virtual machine may not be timely synchronized to a memory or storage. As such, after the virtual machine (guest operating system) is waken up, operation failures may be caused.

Based on this, for the ease that the operation state of the virtual machine (guest operating system) is synchronized to the host operating system, in some embodiments, a state lock service may also be configured on the host operating system of the smart terminal. The state lock service may be a software application for recording operation states of virtual machines running on a smart terminal. When a virtual machine is started up or waken up, the state lock service of the virtual machine may be requested in the host operating system to indicate that the virtual machine enters the operating state. When the virtual machine is disabled or suspended, the state lock service of the virtual machine may be canceled in the host operating system to indicate that the virtual machine enters a shutdown or sleep state. The host operating system correspondingly updates and statistically collects the number of virtual machines using the state lock service. The number of virtual machines using the state lock service is the number of virtual machines that are running. When the number of virtual machines using the state lock service is 0, it indicates that all the virtual machines/guest operating systems on the smart terminal are all in the sleep or shutdown state. In this case, the smart terminal may be allowed to suspend the host operating system. Analogously, if the number of virtual machines currently using the state lock service is not 0, it indicates that a virtual machine is currently running. In this case, the smart terminal may not suspend the host operating system.

Accordingly, an embodiment of the present application further provides another state management method for a virtual machine. The method is different from the suspend method for the virtual machine as illustrated in FIG. 2 and the wake-up method for the virtual machine as illustrated in FIG. 3 in that: in this embodiment, steps for suspending a virtual machine further include: canceling the state lock service of the virtual machine in the host operating system of the smart terminal; and steps for waking up a virtual machine further include: requesting the state lock service of the virtual machine in the host operating system of the smart terminal.

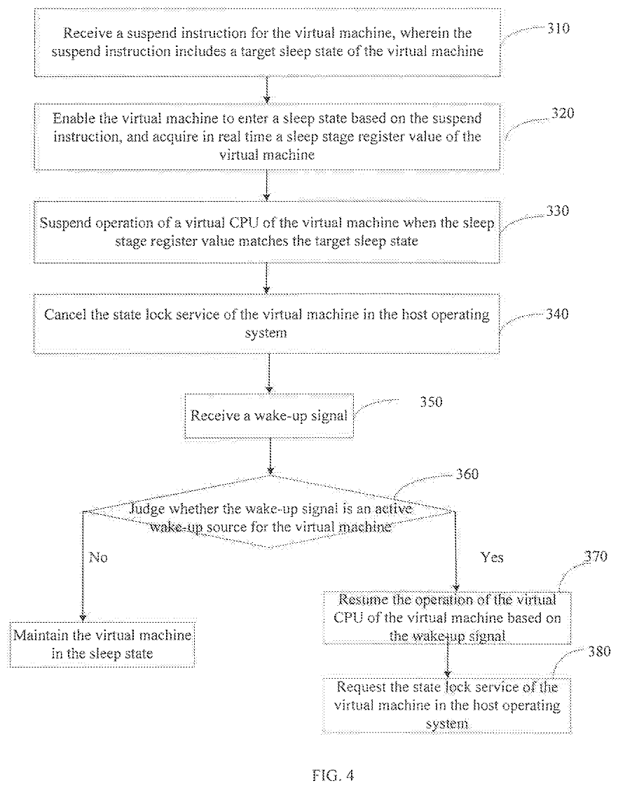

Specifically, referring to FIG. 4, the method includes the following steps.

310: A suspend instruction for the virtual machine is received, wherein the suspend instruction includes a target sleep state of the virtual machine.

320: The virtual machine is enabled to enter a sleep state based on the suspend instruction, and a sleep stage register value of the virtual machine is acquired in real time.

330: Operation of a virtual CPU of the virtual machine is suspended when the sleep stage register value matches the target sleep state.

340: A state lock service of the virtual machine is canceled in the host operating system.

350: A wake-up signal is received.

360: Whether the wake-up signal is an active wake-up source for the virtual machine is judged. If the wake-up signal is an active wake-up source for the virtual machine, steps 370 to 380 are performed; and otherwise, the virtual machine is still maintained in the sleep state.

370: The operation of the virtual CPU of the virtual machine is resumed based on the wake-up signal if the wake-up signal is an active wake-up source for the virtual machine.

380: The state lock service of the virtual machine is requested in the host operating system.

In this embodiment, steps 310 to 330 and steps 350 to 370 respectively have the same technical features with steps 110 to 130 and steps 210 to 230 in the above embodiment, and specific practice thereof also applies to this embodiment, which is thus not described in this embodiment any further.

In addition, it should be noted that, in this embodiment, the “state lock service of the virtual machine” is used to mark an operating state of the virtual machine in the host operating system, instead of locking the virtual machine to the operating state. One state lock may be used, and all the virtual machines in the operating state share this state lock; or a plurality of state locks may be used, and each virtual machine corresponds to one state lock, which is not specifically defined in this embodiment of the present application.

As known from the above technical solution, in the state management method for the virtual machine according to this embodiment of the present application, when a virtual machine is suspended, the state lock service of the virtual machine is canceled in the host operating system; and when a virtual machine is waken up, the state lock service of the virtual machine is requested in the host operating system. In this way, the operation state of the virtual machine may be conveniently synchronized to the host operating system, thereby addressing the problem that the virtual machine is subjected to operation failures after being waken up caused by an abrupt interruption of the operation of the virtual machine due to suspension of the host operating system.

FIG. 5 is a schematic structural diagram of a state management apparatus 5 for a virtual machine according to an embodiment of the present application. Referring to FIG. 5, the apparatus 5 includes:

a suspend instruction receiving unit 51, configured to receive a suspend instruction for the virtual machine, the suspend instruction including a target sleep state of the virtual machine;

a sleeping unit 52, configured to enable the virtual machine to enter a sleep state based on the suspend instruction, and acquire in real-time a sleep stage register value of the virtual machine; and

a suspending unit 53, configured to suspend operation of a virtual CPU of the virtual machine when the sleep stage register value matches the target sleep state.

In this embodiment of the present application, when the suspend instruction receiving unit 51 receives the suspend instruction including the target sleep state of the virtual machine, the sleeping unit 51 enables the virtual machine to enter the sleep state based on the suspend instruction, and acquires in real time the sleep stage register value of the virtual machine. When the sleep stage register value matches the target sleep state, the suspending unit 53 suspends the operation of the virtual CPU of the virtual machine.

In some embodiments, the apparatus 5 further includes:

a wake-up signal receiving unit 54, configured to receive a wake-up signal;

a judging unit 55, configured to judge whether the wake-up signal is an active wake-up source for the virtual machine; and

a resuming unit 56, configured to resume the operation of the virtual CPU of the virtual machine based on the wake-up signal if the wake-up signal is an active wake-up source for the virtual machine.

In this embodiment, when the virtual machine is in a sleep state, the wake-up signal receiving unit 51 receives a wake-up signal; the judging unit 55 judges whether the wake-up signal is an active wake-up source for the virtual machine; and if the wake-up signal is an active wake-up source for the virtual machine, the resuming unit 56 resumes the operation of the virtual CPU based on the wake-up signal.

When a host operating system of the smart terminal is provided with a state lock service, the apparatus 5 further includes: a canceling unit 57, configured to cancel the state lock service of the virtual machine in the host operating system if the sleep stage register value matches the target sleep state; and/or a requesting unit, configured to request the state lock service of the virtual machine in the host operating system if the wake-up signal is an active wake-up source for the virtual machine.

The judging unit 55 is specifically configured to: acquire a wake-up serial number corresponding to the wake-up signal; judge whether the wake-up serial number matches a wake-up register value of the virtual machine; and determine that the wake-up signal is the active wake-up source for the virtual machine if the wake-up serial number matches a wake-up register value of the virtual machine.

The resuming unit 56 is specifically configured to: acquire a wake-up source type of the wake-up signal, and resume the operation of the virtual CPU of the virtual machine based on the wake-up source type.

When at least two wake-up signals are included, and each wake-up signal has a priority level, the apparatus 5 further includes: a selecting unit 59, configured to extract a wake-up signal having a highest priority among the wake-up signals. In this case, the judging unit 55 is specifically configured to: judge whether the wake-up signal having the highest priority is an active wake-up source for the virtual machine; and the resuming unit 56 is specifically, configured to: resume the operation of the virtual CPU of the virtual machine based on the wake-up signal having the highest wake-up signal.

It should be noted that since the state management apparatus for the virtual machine and the state management method for the virtual machine in the above method embodiment are based on the same inventive concept, relevant content disclosed the above method embodiments and the beneficial effects thereof also apply to the apparatus embodiment, which are not described herein any further.

As known from the above technical solution, the state management apparatus for the virtual machine according to the embodiment of the present application achieves the following beneficial effects: when the suspend instruction receiving unit 51 receives the suspend instruction including the target sleep state of the virtual machine, the sleeping unit 52 enables the virtual machine to enter the sleep state based on the suspend instruction, and acquires in real time the sleep stage register value of the virtual machine; when the sleep stage register value matches the target sleep sate, the suspending unit 53 suspends the operation of the virtual CPU of the virtual machine. In this way, the virtual machine may be completely suspended, and the virtual machine is prevented from being mis-waken up due to the interrupt signal generated by the virtual clock, thereby improving an energy saving effect of the system.

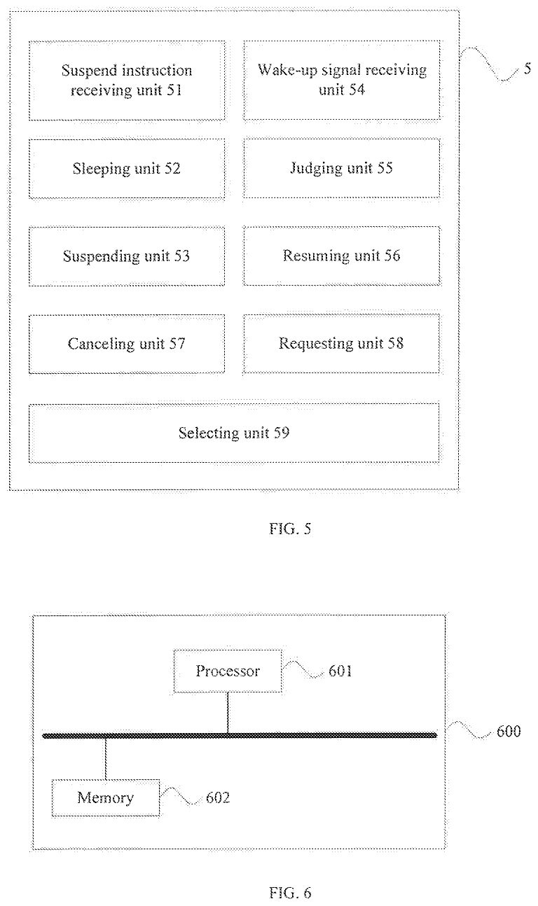

FIG. 6 is a schematic structural diagram illustrating hardware of a smart terminal 600 according to an embodiment of the present application. The smart terminal 600 may be any type of smart terminals, for example, a mobile phone, a tablet computer, a server, a robot or the like, which is capable of performing the state management method for the virtual machine (the suspend method for the virtual machine and/or the wake-up method for the virtual machine) as described above.

Specifically, referring to FIG. 6, the smart terminal 600 includes:

at least one processor 601 and a memory 602, wherein FIG. 6 uses one processor 601 as an example.

The at least one processor 601 and the memory 602 may be connected via a bus or in another manner, and FIG. 6 uses connection via the bus as an example.

The memory 602, as a non-transitory computer-readable storage medium, may be configured to store non-transitory software programs, non-transitory computer-executable programs and modules, for example, the program instructions/modules for performing the state management methods for the virtual machine according to the embodiments of the present application (for example, the suspend instruction receiving unit 51, the sleeping unit 52, the suspending unit 53, the wake-up signal receiving unit 54, the judging unit 55, the resuming unit 56, the canceling unit 57. The requesting unit 58 and the selecting unit 59 as illustrated in FIG. 5). The non-transitory software programs, instructions and modules stored in the memory 601, when being executed, cause the processor 602 to perform various function applications and data processing of a smart terminal, that is, performing the state management methods for the virtual machine according to the above method embodiments.

The memory 602 may include a program memory area and data memory area, wherein the program memory area may store operation systems and application programs needed by at least function; and the data memory area may store data created according to the usage of the state management apparatus for the virtual machine. In addition, the memory 602 may include a high speed random access memory, or include a non-transitory memory, for example, at least one disk storage device, a flash memory device, or another non-transitory solid storage device. In some embodiments, the memory 602 optionally includes memories remotely configured relative to the processor 601. These memories may be connected to the smart terminal 600 over a network. Examples of the above network include, but not limited to, the Internet, Intranet, local area network, mobile communication network and a combination thereof.

One or a plurality of modules are stored in the memory 602, which, when being executed by the at least one processor 601, perform the state management method for the virtual machine according to any of the above method embodiments, for example, performing steps 110 to 130 in the method as illustrated in FIG. 2, steps 210 to 230 in the method as illustrated in FIG. 3 and steps 310 to 380 in the method as illustrated in FIG. 4, and implementing the functions of units 51 to 59 in the apparatus as illustrated in FIG. 5.

An embodiment of the present application further provides a non-transitory computer-readable storage medium, wherein the computer-readable storage medium stores computer executable instructions, which, when being executed by the at least one processor, for example, the at least one processor 601 as illustrated in FIG. 8, cause the at least one processor 810 to perform the state management method for the virtual machine in any of the above method embodiments, for example, performing steps 110 to 130 in the method as illustrated in FIG. 2, steps 210 to 230 in the method as illustrated in FIG. 3 and steps 310 to 380 in the method as illustrated in FIG. 4, and implementing the functions of units 51 to 59 in the apparatus as illustrated in FIG. 5.

The above described system embodiments are merely for illustration purpose only. The units which are described as separate components may be physically separated or may he not physically separated, and the components which are illustrated as units may be or may not be physical units, that is, the components may be located in the same position or may be distributed into a plurality of network units. A part or all of the modules may be selected according to the actual needs to achieve the objectives of the technical solutions of the embodiments.

According to the above embodiments of the present application, a person skilled in the art may clearly understand that the embodiments of the present application may be implemented by means of hardware or by means of software plus a necessary general hardware platform. Persons of ordinary skill in the art may understand that all or part of the steps of the methods in the embodiments may be implemented by a program instructing relevant hardware. The program may be stored in a non-transitory computer-readable storage medium and may be executed by at least one processor. When the program runs, the steps of the methods in the embodiments are performed. The storage medium may be any medium capable of storing program codes, such as read-only memory (ROM), a random access memory (RAM), a magnetic disk, or a compact disc-read only memory (CD-ROM).

The product may perform the method according to the embodiments of the present application, has corresponding function modules for performing the method, and achieves the corresponding beneficial effects. For technical details that are not illustrated in detail in this embodiment, reference may be made to the description of the methods according to the embodiments of the present application.

Finally, it should be noted that the above embodiments are merely used to illustrate the technical solutions of the present application rather than limiting the technical solutions of the present application. Under the concept of the present application, the technical features of the above embodiments or other different embodiments may be combined, the steps therein may be performed in any sequence, and various variations may be derived in different aspects of the present application, which are not detailed herein for brevity of description. Although the present application is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present application.

What is claimed is:

1. A state management method for a virtual machine, comprising;
at a smart terminal:
receiving a suspend instruction for the virtual machine, the suspend instruction comprising a target sleep state of the virtual machine;
enabling the virtual machine to enter a sleep state based on the suspend instruction;
acquiring in real-time a sleep stage register value of the virtual machine; and
suspending operation of a virtual CPU of the virtual machine when the sleep stage register value matches the target sleep state.

2. The method according to claim 1, further comprising;
receiving a wake-up signal;
judging whether the wake-up signal is an active wake-up source for the virtual machine; and
resuming the operation of the virtual CPU of the virtual machine based on the wake-up signal if the wake-up signal is the active wake-up source for the virtual machine.

3. The method according to claim 1, wherein when a host operating system of the smart terminal is provided with a state lock service, the method further comprises:
canceling the state lock service of the virtual machine in the host operating system.

4. The method according to claim 3, further comprising:
receiving a wake-up signal;
judging whether the wake-up signal is an active wake-up source for the virtual machine; and
resuming the operation of the virtual CPU of the virtual machine based on the wake-up signal and requesting the state lock service of the virtual machine in the host operating system if the wake-up signal is the active wake-up source for the virtual machine.

5. The method according to claim 2, wherein the judging whether the wake-up signal is the active wake-up source for the virtual machine comprises:
acquiring a wake-up serial number corresponding to the wake-up signal;
judging whether the wake-up serial number matches a wake-up source register value of the virtual machine; and
determining that the wake-up signal is the active wake-up source for the virtual machine if the wake-up serial number matches the wake-up source register value of the virtual machine.

6. The method according to claim 2, wherein the resuming the operation of the virtual CPU of the virtual machine based on the wake-up signal comprises:
acquiring a wake-up source type of the wake-up signal; and
resuming the operation of the virtual CPU of the virtual machine based on the wake-up source type.

7. The method according to claim 2, wherein at least two wake-up signals are included, and each wake-up signal has a priority level;
prior to the step of judging whether the wake-up signal is the active wake-up source for the virtual machine, the method further comprises:
extracting a wake-up signal having a highest priority among the wake-up signals;
the judging whether the wake-up signal is the active wake-up source for the virtual machine comprises:
judging whether the wake-up signal having the highest priority is the active wake-up source for the virtual machine; and
the resuming the operation of the virtual CPU of the virtual machine based on the wake-up signal comprises:
resuming the operation of the virtual CPU of the virtual machine based on the wake-up signal having the highest wake-up signal.

8. A smart terminal, comprising:
at least one processor; and
a memory communicably connected to the at least one processor; wherein
the memory stores instructions executable by the at least one processor, wherein, the instructions, when being executed by the at least one processor, cause the at least one processor to perform the method as in claim 1.

9. A non-transitory computer readable storage medium, wherein the non-transitory computer-readable storage medium stores computer-executable instructions, which, when being executed by a smart terminal, cause the smart terminal to perform the method as in claim 1.
